(19) United States
(12) Patent Application Publication
(10) Pub. No.: US 2025/0123675 A1
(43) Pub. Date: Apr. 17, 2025

(54) COMPUTING SYSTEM POWER OPTIMIZATION BASED ON RUNTIME METRICS

(71) Applicant: Intel Corporation, Santa Clara, CA (US)

(72) Inventors: Deepak Samuel Kirubakaran, Hillsboro, OR (US); Ho Jeong An, Portland, OR (US); Nisha Aram, Hillsboro, OR (US); Sravya Atluri, Santa Clara, CA (US); Simonjit Dutta, Sammamish, WA (US); Darwin Guo, Santa Clara, CA (US); Linlin Hou, Portland, OR (US); Yishin Huang, Portland, OR (US); Ho Kyu Kang, Portland, OR (US); Brice Onken, Hillsboro, OR (US); Veeraraghavan Ramaraj, Hillsboro, OR (US); Cameron Rieck, Portland, OR (US); Malavika Srinivas, Hillsboro, OR (US); Venkateshan Udhayan, Portland, OR (US); Fidel Angel Vanegas Patino, Vancouver, WA (US); Zhongsheng Wang, Ridgefield, WA (US); Ulises Zaragoza, Santa Clara, CA (US)

(21) Appl. No.: 18/990,429

(22) Filed: Dec. 20, 2024

(51) Int. Cl. G06F 1/3296

(52) U.S. Cl. CPC G06F 1/3296

(57) ABSTRACT

A component of a computing system, including: processor circuitry; and a non-transitory computer-readable storage medium including instructions that, when executed by the processor circuitry, cause the processor circuitry to: dynamically monitor runtime metrics across processor cores of the computing system, wherein the runtime metrics comprise a measure of system-critical task residency and a measure of user-critical foreground application utilization; and initiate a power optimization action configured to transition the computing system into a power efficiency mode when the system-critical task residency is below a system-critical task residency threshold and the user-critical foreground application utilization is below a user-critical foreground application utilization threshold.

### BACKGROUND

Power management policies and performance preferences in operating systems (OS) and hardware/firmware are typically statically configured by OS vendors (OSVs), original equipment manufacturers (OEMs), original design manufacturers (ODMs), and independent hardware vendors (IHVs). These static configurations fail to adapt effectively to real-world usage scenarios, such as user idle states, browsing, productivity, and collaboration tasks, particularly under varying background activity (e.g., background services and applications such as ergonomic monitors, repetitive strain injury (RSI) guards, and other information technology (IT) software). The lack of dynamic synergy between the OS and hardware results in suboptimal power scaling, leading to high system-on-chip (SOC) and platform power consumption. Studies of real-world systems reveal significantly elevated SOC power usage for low-power activities like browsing or productivity due to the inability of OS and hardware algorithms to adapt to background activity.

Existing solutions, such as hardware-guided scheduling (HGS) and HGS+, are limited to thread-level feedback and scalability optimizations tied to instruction set architectures (ISA) and similar factors. However, they do not account for system-wide contexts, including factors such as CLOS-0 (class of service-0) residency across cores, foregrounds application usage, core concurrency, memory usage, and usage of accelerators like neural processing units (NPUs) and graphics processing units (GPUs). These limitations prevent effective optimization for platform-wide power efficiency while preserving user experience.

### DESCRIPTION OF THE FIGURES

FIG. 1 is a block diagram illustrating a computing system architecture configured to implement dynamic, context-aware power optimization techniques in accordance with aspects of the disclosure.

FIG. 2 is a flowchart illustrating a decision-making process for identifying power optimization opportunities and applying corresponding power management actions.

FIG. 3 shows two comparative bar charts illustrating how issuing an efficiency hint affects the classification of workloads.

### DETAILED DESCRIPTION

The present disclosure provides a hardware-firmware coordinated mechanism to optimize platform-wide power efficiency in computing systems under real-world conditions. Existing power management policies for processors, including idle selection and performance preferences for performance (P) and efficiency (E) cores, are not dynamically optimized for varying operating scenarios (e.g., foreground, background, critical, non-critical). As a result, sub-optimal processor states and core parking configurations often degrade power efficiency and user experience.

Current hardware and firmware algorithms for thread assignment and core frequency management primarily rely on metrics like core utilization and instructions per cycle (IPC), with little consideration of user experience. This results in non-critical tasks consuming excessive power by running on high-performance cores or operating at unnecessarily high frequencies. Additionally, these algorithms are not scalable for real-world workloads, leading to inefficient System Agent Voltage (SAGV) points, performance-energy (P-e) calculations, and firmware clipping (P-code). The disclosed mechanism integrates OS metadata—such as task importance, application utilization, and class-of-service (CLOS) designations—into these algorithms, enabling more intelligent resource allocation and greater energy efficiency, particularly in enterprise IT scenarios.

By leveraging OS-derived contextual information (e.g., CLOS-0 residency, core concurrency, and memory usage), this approach identifies power optimization opportunities, including selecting suitable SAGV points, adjusting performance sliders, refining hardware power management (HWP) algorithms, and predicting workload types (e.g., bursty or sustained). Workloads are characterized based on system-wide metrics like CLOS-0 residency, foreground CPU utilization, and resource usage across components (CPU, GPU, memory). For low-priority workloads, the system enhances efficiency by optimizing un-core (SAGV) states, sending SOC slider hints to firmware, and applying OS power-saving settings. Dynamic adjustments, such as throttling E-cores or selectively parking P-cores based on workload and system metrics, improve thermals and acoustics while maximizing power efficiency. These measures ensure adaptable and efficient platform operation under real-world conditions.

The present disclosure describes a hardware-firmware coordinated mechanism to detect and optimize platform-wide power efficiency in computing systems operating under real-world conditions. System-on-Chip (SOC) and operating system (OS) power management policies, including processor idle selection and processor performance preferences for both performance (P) and efficiency (E) cores, in existing computing systems cannot be statically optimized for varying operating environments and usage scenarios (foreground, background, critical, non-critical). As a result, sub-optimal processor performance states and core parking configurations frequently occur, degrading the user experience and overall power efficiency.

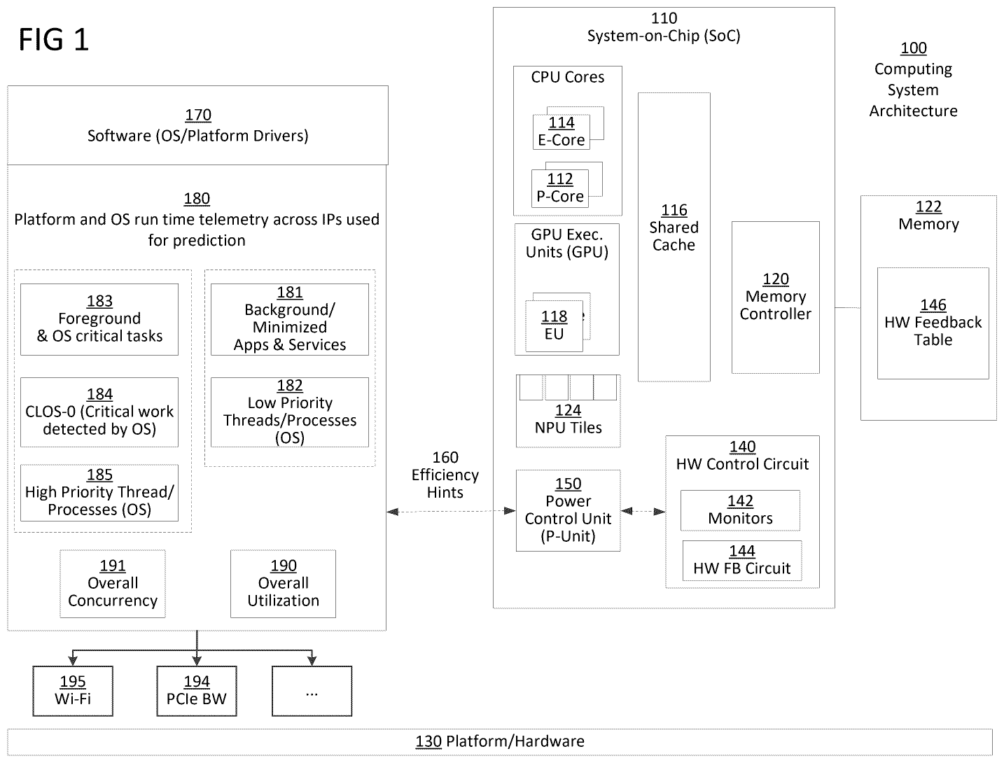

FIG. 1 is a block diagram illustrating an architecture of computing system 100 configured to implement dynamic, context-aware power optimization techniques in accordance with aspects of the disclosure.

Generally, the computing system 100 is equipped to leverage OS-derived user context and hardware telemetry to dynamically adjust power management decisions. Computing system 100 thereby balances performance requirements during user-critical tasks against power efficiency goals during background or low-priority activities.

The computing system 100 includes a System-on-Chip (SoC) 110 coupled to various platform-level components 130. The SoC 110 may integrate a heterogeneous processing environment comprising one or more performance cores (P-cores) 112 and one or more efficiency cores (E-cores) 114, collectively referred to as CPU cores. In addition, the SoC 110 may include a shared cache 116, Graphics Processing Units (GPU) or Execution Units (EUs) 118, a memory controller 120 for managing and interfacing with system memory 122, and optionally Neural Processing Unit (NPU) tiles 124 or other accelerators as applicable. These components may communicate over one or more internal interconnect fabrics (not shown).

The memory controller 120 is configured to manage data flow between the CPU cores 112 and 114 and the system memory 122, which may be dynamic random-access memory (DRAM) or other suitable memory technology. The shared cache 116 provides a high-speed intermediate storage medium to reduce latency and improve performance.

The SoC 110 further comprises a hardware control circuit 140 including one or more monitors 142 and a hardware feedback circuit 144. These hardware elements gather and process real-time telemetry data from various system components, including CPU utilization levels, memory bandwidth usage, GPU load, and other performance or power-related metrics. The hardware feedback circuit 144 may generate low-level control signals or feedback tables, such as Hardware Feedback Interface (HFI) tables 146, which may contain instructions, hints, or parameters for power management and performance scaling, as is generally known.

Coupled with the hardware control circuit 140 is a power control unit (P-unit) 150. The P-unit 150 is a specialized hardware/firmware element responsible for implementing power management policies at the platform level. It may receive platform efficiency hint signals 160 from higher-level software components and translate these hints into low-level voltage-frequency scaling decisions, core parking actions, or adjustments in memory controller behavior and peripheral link states. By doing so, it dynamically modulates the SoC's operating point to achieve power efficiency without significantly impacting user experience.

The operating system (OS) and associated platform drivers or firmware 170 supply critical runtime telemetry data and contextual metadata to the SoC 110. This includes OS-level classifications of running tasks, such as whether an application is in the foreground 183 or background 181, whether a thread or process is designated as a high-priority 185 or critical (e.g., CLOS-0) workload 184, and other system-level hints. As shown, platform and OS runtime telemetry 180 provides a comprehensive view of system load across various IP blocks. For instance, it can distinguish between background applications 181, low-priority threads/processes 182, and critical or foreground tasks 183. These OS-level contextual inputs are combined with hardware monitors' data to form a holistic understanding of current workload conditions.

Overall utilization 190 and concurrency metrics 191 are also provided as part of the telemetry. These metrics inform whether the computing system 100 is lightly loaded with predominantly background tasks or if performance-critical workloads are active. By integrating these software and hardware signals, the SoC 110, through the P-unit 150, can select actions that improve platform power efficiency. For example, when non-critical workloads dominate, PCIe bandwidth 194, Wi-Fi 195, and other platform interfaces may be downshifted to more power-efficient states, while CPU and un-core components operate at lower voltage-frequency points (SAGV states). This dynamic approach ensures that static optimization is unnecessary, as the computing system 100 can adapt to the current workload conditions, providing power savings without compromising responsiveness when critical workloads appear.

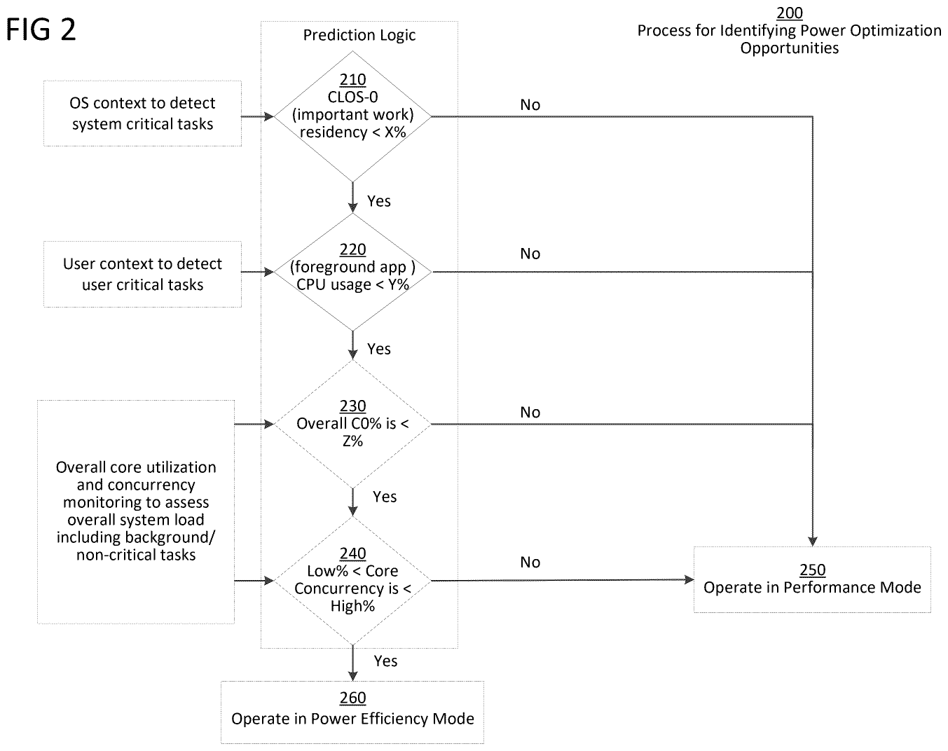

FIG. 2 is a flowchart illustrating a decision-making process 200 for identifying power optimization opportunities and applying corresponding power management actions. Starting from the left-hand side of the figure, the process evaluates multiple OS and platform-derived signals, applying a series of conditional checks. The depicted logic may be implemented in hardware, firmware (e.g., P-code), software, or a combination thereof.

Generally, FIG. 2 provides a logic flow illustrating how contextual OS signals, workload characterization, and concurrency/utilization metrics guide the computing system 100 from a performance-oriented state to a power-efficient state and back as necessary. The flowchart also highlights how the aspects of the disclosure leverage software-provided context and internal telemetry to fine-tune hardware power states dynamically.

The “Prediction Logic” represents an intelligence layer of the P-unit 150 that aggregates the aforementioned OS and platform telemetry signals to predict whether the current workload pattern matches scenarios suitable for power optimization. If conditions confirm that the computing system 100 is either under low load, dominated by background tasks, or lacking any user-critical workloads, the logic reaches a stage where it can trigger power efficiency actions. Conversely, if any metric indicates that critical workloads or user-focused tasks are running, the computing system 100 refrains from aggressive power-saving measures to ensure responsiveness and performance.

Turning to the specifics of process 200, at the first decision step 210, computing system 100 checks if CLOS-0 or other designated “important workload” (system-critical tasks) residency is below a predefined threshold of X %. In the disclosed aspects, a system-critical task refers to a task that is essential to the proper functioning of the computing system 100, meaning if it fails, the computing system 100 could experience significant disruptions or become unusable, often leading to severe consequences like data loss, operational downtime, or safety hazards depending on the context. In this example, a system-critical task is defined as a task associated with a class of service identifying a higher priority operational requirement. This is from the OS perspective.

The computing system 100 operates in or transitions to a performance mode (step 260) when the system-critical task residency is above the system-critical task residency threshold X % (the check result is “No”), indicating the presence of important workloads that require higher performance states. The computing system 100 thus maintains higher performance states to ensure responsiveness at step 250. Otherwise the check result is “Yes,” and the computing system 100 may transition to or continue to operate in a power efficiency mode at step 260.

The predefined threshold X % may be defined as suitable for the particular computing system. For example, the predefined threshold X % may be defined as the utilization equivalent of one fully occupied CPU core (thread) within the computing system 100. For instance, if computing system 100 includes twelve CPU cores and one CPU core is 100% busy with system-critical (important) work during a given interval (e.g., 100 ms), that usage corresponds to the predefined threshold. When the computed residency is less than the workload of a single fully utilized CPU core, the predefined threshold X % scales based on the total number of CPU cores. For example, with ten CPU cores, one CPU core represents 10% of the available processing resources; with twenty CPU cores, one core corresponds to 5%. In this manner, the predefined threshold may be adjusted in proportion to the number of CPU cores, effectively functioning as a tunable parameter that can be scaled to any computing system size or configuration.

CLOS is known, with CLOS-0 being configured as the highest priority CLOS. This metric indicates how much critical or high-priority work CPU cores are handling. A high residency suggests that computing system 100 may need to maintain higher performance states, while a low residency signals an opportunity to conserve power.

Next, at decision step 220, if foreground application CPU core usage (e.g., percentage of processor core cycles consumed by a user-focused or foreground application) is above a predefined threshold of Y %, that is, the decision is “No,” the computing system 100 concludes that the user is actively engaged with a user-critical application and continues to prioritize performance at step 250. A user-critical task refers to a task that a user would consider important for a good user experience, according to system design. The user-critical foreground application utilization threshold may correspond to a utilization equivalent of one fully occupied processor core. When the user-critical foreground application utilization is above its threshold, the system maintains performance mode at step 250 to ensure enhanced user experience. This is from the user's perspective. This decision step 220 may be based on CPUs only, but can possibly be based on XPUs. However, if the decision is “Yes,” the computing system 100 may transition to a power efficiency mode at step 260. High foreground application usage suggests performance should remain robust, while low usage might permit lower power states.

The dynamic monitoring of system-critical task residency is performed across central processor unit (CPU) cores, while the dynamic monitoring of user-critical foreground application utilization may be performed across heterogeneous processor cores including CPU, graphics processor unit (GPU), and neural processor unit (NPU) cores.

Both threshold X % (important work) and threshold Y % (foreground application utilization) may be set to correspond to the utilization of one fully occupied processor core. However, if the desired power management strategy varies based on different levels of background activity, distinct thresholds may be employed. For example, if a resource-intensive task, such as an antivirus or memory scan, causes all processor cores to run at 100% utilization, the computing system 100 may adopt more aggressive power-saving or workload-shifting measures. Conversely, if only two or three processor cores are fully utilized, the computing system 100 might select less aggressive actions. This flexibility ensures that the response can be tailored to a wide range of workload intensities and operational conditions.

If CLOS-0 residency is low (decision step 210) and foreground app CPU usage is low (decision step 220), the logic infers that the computing system 100 is not currently running critical, time-sensitive tasks in the foreground and may transition to or maintain a power efficiency mode at step 260. Optionally, process 200 includes decision steps 230 and 240 to consider system-wide metrics by evaluating concurrency and/or memory bandwidth usage to finalize whether to downshift performance and save power.

Specifically, at decision step 230, the runtime metrics may optionally include a measure of overall processor core utilization. The computing system 100 initiates the power optimization action to transition into power efficiency mode (step 260) when the overall processor core utilization is below an overall processor core utilization threshold Z %. Conversely, the computing system 100 operates in or transitions to performance mode at step 250 when the overall processor core utilization is above the threshold Z %.

At decision step 240, the runtime metrics optionally additionally or alternatively comprise a measure of overall processor core concurrency (number of active threads or processes). The computing system 100 initiates the power optimization action to transition into power efficiency mode (step 260) when the overall processor core concurrency is within a predefined overall processor core concurrency range bounded by Low % and High % values. The computing system 100 operates in or transitions to performance mode (step 250) when the overall processor core concurrency is outside of this predefined range. If overall concurrency surpasses the high threshold and is not correlated with high-priority tasks, it still may represent a background load scenario. Low utilization or low concurrency, combined with a lack of critical tasks, identifies scenarios where performance headroom is not required.

Once conditions are met for power efficiency mode, action step 260 initiates communication of an efficiency hint signal 160 to the P-unit 150 within the SoC 110 to perform hardware and/or software actions. This efficiency hint signal 160 may instruct the SoC's firmware (P-code) to adjust operating points through specific actions. The power optimization actions may include dynamically parking a subset of the P-cores 112. These actions can reduce peripheral component interconnect bandwidth, as well as processor core frequency, memory frequency, or Wi-Fi power.

For example, the computing system 100 may optimize voltage and frequency scaling for un-core components (e.g., CPU/GPU/NPU) by selecting a more energy-efficient SAGV operating point. It may also constrain power-intensive resources, such as downgrading PCIe link speeds or reducing bandwidth for NPU tiles 124 or execution units 118 when high performance is unnecessary. Additionally, the computing system 100 can migrate low-priority or background threads to more E-cores 114 while parking or gating select P-cores 112 to reduce power consumption.

The computing system 100 may further or alternatively adjust OS, device, and/or platform performance management settings to reflect an energy-efficient operating mode. These adjustments may include managing latency tolerances, device power states, and other platform-level optimizations to ensure effective scaling for real-world usage while addressing the limitations of static configurations.

If, after applying power-efficient adjustments, a new critical task emerges, the computing system 100 can re-check the conditions and revert to a more performance-focused state in action step 250. This disclosure, context-aware strategy ensures minimal user impact while delivering significant power savings and improved battery life. By continuously predicting and responding to real-world workload conditions, the aspects of the disclosure ensure that the platform maintains optimal SAGV points, properly calculates P-e and P-alpha clipping, and manages power states in a manner that aligns with actual user experience demands and system utilization patterns.

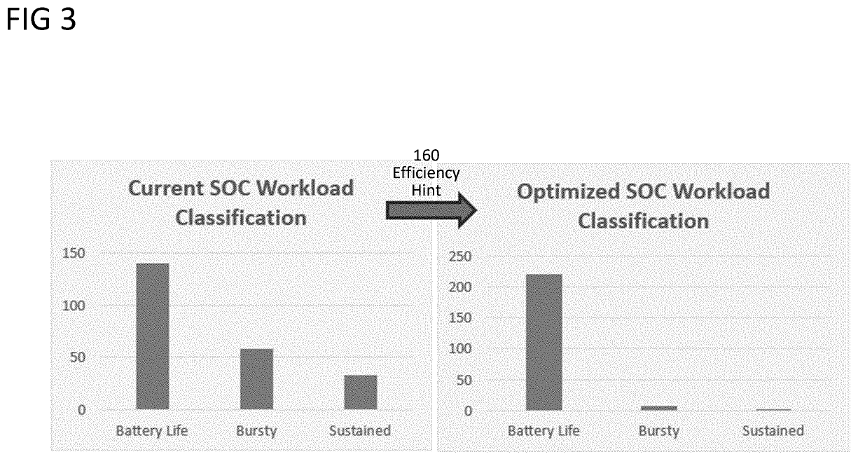

FIG. 3 shows two comparative bar charts 300 illustrating how issuing an “Efficiency Hint” 160 affects the classification of SoC workloads. The bar chart on the left, labeled “Current SOC Workload Classification,” depicts the initial distribution of workloads among categories such as “Battery Life,” “Bursty,” and “Sustained.” The y-axis represents the number of workload instances in each category. In this initial state, a significant portion of workloads are categorized as “Bursty” or “Sustained.”

An arrow labeled “Efficiency Hint” points from the left bar chart to the right bar chart, indicating that after receiving the efficiency hint signal 160, the computing system 100 redistributes the workload classification. The bar chart on the right, labeled “Optimized SOC Workload Classification,” shows a higher number of tasks falling under the “Battery Life” category, with correspondingly fewer “Bursty” and “Sustained” workloads. This shift demonstrates that computing system 100 successfully adapted its classification strategy to prioritize energy efficiency without compromising performance, thereby aligning the workload distribution more closely with optimal battery life conditions.

The computing system includes processor circuitry and a non-transitory computer-readable storage medium that may be located in one or more locations within the architecture of computing system 100. The computer-readable storage medium includes instructions that, when executed by the processor circuitry, cause the processor circuitry to implement the described functionality. The component described herein is comprised within the P-unit 150 of the System-on-Chip (SoC) 110, enabling direct implementation of power management policies at the platform level.

The aspects disclosed herein integrate additional user experience context into existing hardware (HW) and firmware (FW) power management and scheduling algorithms.

Conventional approaches rely predominantly on architectural metrics—such as core utilization and instructions per cycle (IPC)—and lack an understanding of task importance relative to user experience. By incorporating OS-sourced metadata, including thread priority and real-time application focus, the disclosed solution enables a more nuanced allocation of threads to performance and efficiency cores, as well as more intelligent frequency scaling decisions. This improvement is particularly valuable in real-world corporate IT environments, where numerous non-critical background activities may otherwise consume unnecessary power by running on high-performance cores or triggering increased operating frequencies. As a result, the disclosed aspects enhance overall platform efficiency while preserving responsiveness and performance during user-critical workloads.

Further, the disclosed aspects enable extended battery life while maintaining high performance and responsiveness. This hardware-firmware coordinated mechanism is scalable across a broad spectrum of real-world use cases, ensuring a seamless and enhanced user experience. It achieves substantial power savings, delivering approximately 38% package power reduction during active light tasks, such as web page scrolling, and around 15% power savings during real-world idle periods.

The techniques of this disclosure may also be described in the following examples.

Example 1. A component of a computing system, comprising: processor circuitry; and a non-transitory computer-readable storage medium including instructions that, when executed by the processor circuitry, cause the processor circuitry to: dynamically monitor runtime metrics across processor cores of the computing system, wherein the runtime metrics comprise a measure of system-critical task residency and a measure of user-critical foreground application utilization; and initiate a power optimization action configured to transition the computing system into a power efficiency mode when the system-critical task residency is below a system-critical task residency threshold and the user-critical foreground application utilization is below a user-critical foreground application utilization threshold.

Example 2. The component of example 1, wherein a system-critical task is defined as a task associated with a class of service identifying a higher priority operational requirement.

Example 3. The component of any one or more of examples 1-2, wherein the system-critical task residency threshold corresponds to a utilization equivalent of one fully occupied processor core.

Example 4. The component of any one or more of examples 1-3, wherein the user-critical foreground application utilization threshold corresponds to a utilization equivalent of one fully occupied processor core.

Example 5. The component of any one or more of examples 1-4, wherein the instructions further cause the processor circuitry to: operate the computing system in or transition to a performance mode when the system-critical task residency is above the system-critical task residency threshold or the user-critical foreground application utilization is below the user-critical foreground application utilization threshold, indicating a higher load condition.

Example 6. The component of any one or more of examples 1-5, wherein: the runtime metrics further comprise a measure of overall processor core utilization, and the instructions further cause the processor circuitry to: initiate the power optimization action to transition the computing system into the power efficiency mode when the overall processor core utilization is below an overall processor core utilization threshold.

Example 7. The component of example 6, wherein the instructions further cause the processor circuitry to: operate the computing system in or transition to a performance mode when the overall processor core utilization is above the overall processor core utilization threshold.

Example 8. The component of any one or more of examples 1-7, wherein: the runtime metrics further comprise a measure of overall processor core concurrency, and the instructions further cause the processor circuitry to: initiate the power optimization action to transition the computing system into the power efficiency mode when the overall processor core concurrency is within a predefined overall processor core concurrency range.

Example 9. The component of example 8, wherein the instructions further cause the processor circuitry to: operate the computing system in or transition to a performance mode when the overall processor core concurrency is outside of the predefined overall processor core concurrency range.

Example 10. The component of any one or more of examples 1-9, wherein the dynamic monitoring of system-critical task residency is performed across central processor unit (CPU) cores, and the dynamic monitoring of user-critical foreground application utilization is performed across heterogeneous processor cores.

Example 11. The component of example 10, wherein the heterogeneous processor cores comprise a central processor unit (CPU), graphics processor unit (GPU), and/or neural processor unit (NPU) cores.

Example 12. The component of any one or more of examples 1-11, wherein the initiation of the power optimization action comprises transmitting a power efficiency signal to a power control unit of the computing system.

Example 13. The component of any one or more of examples 1-12, wherein the power optimization action comprises dynamically parking a subset of the processor cores that are performance-oriented processor cores.

Example 14. The component of any one or more of examples 1-13, wherein the power optimization action results in a reduction of peripheral component interconnect bandwidth.

Example 15. The component of any one or more of examples 1-14, wherein the power optimization action results in a reduction in processor core frequency, memory frequency, or Wi-Fi power.

Example 16. The component of any one or more of examples 1-15, wherein the component is comprised within a power control unit of a System-on-Chip (SoC).

Example 17. A computing system, comprising: a System-on-Chip (SoC) including processor cores and a power control unit; processor circuitry executing an operating system, which is configured to: dynamically monitor runtime metrics across the processor cores, wherein the runtime metrics comprise a measure of system-critical task residency and a measure of user-critical foreground application utilization; and initiate a power optimization action by transmitting a power efficiency signal to the power control unit, wherein the power control unit is configured to transition the SoC into a power efficiency mode when the system-critical task residency is below a system-critical task residency threshold and the user-critical foreground application utilization is below a user-critical foreground application utilization threshold.

Example 18. The computing system of example 17, wherein: the runtime metrics further comprise a measure of overall processor core utilization, and the processor circuitry executing the operating system is further configured to: initiate the power optimization action to transition the computing system into the power efficiency mode when the overall processor core utilization is above an overall processor core utilization threshold.

Example 19. The computing system of any one or more of examples 17-18, wherein: the runtime metrics further comprise a measure of overall processor core concurrency, and the processor circuitry executing the operating system is further configured to: initiate the power optimization action to transition the computing system into the power efficiency mode when the overall processor core concurrency is within a predefined overall processor core concurrency range.

While the foregoing has been described in conjunction with exemplary aspects, it is understood that the term “exemplary” is merely meant as an example, rather than the best or optimal. Accordingly, the disclosure is intended to cover alternatives, modifications, and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A component of a computing system, comprising:
processor circuitry; and
a non-transitory computer-readable storage medium including instructions that, when executed by the processor circuitry, cause the processor circuitry to:
dynamically monitor runtime metrics across processor cores of the computing system, wherein the runtime metrics comprise a measure of system-critical task residency and a measure of user-critical foreground application utilization; and
initiate a power optimization action configured to transition the computing system into a power efficiency mode when the system-critical task residency is below a system-critical task residency threshold and the user-critical foreground application utilization is below a user-critical foreground application utilization threshold.

2. The component of claim 1, wherein a system-critical task is defined as a task associated with a class of service identifying a higher priority operational requirement.

3. The component of claim 1, wherein the system-critical task residency threshold corresponds to a utilization equivalent of one fully occupied processor core.

4. The component of claim 1, wherein the user-critical foreground application utilization threshold corresponds to a utilization equivalent of one fully occupied processor core.

5. The component of claim 1, wherein the instructions further cause the processor circuitry to:
operate the computing system in or transition to a performance mode when the system-critical task residency is above the system-critical task residency threshold or the user-critical foreground application utilization is below the user-critical foreground application utilization threshold, indicating a higher load condition.

6. The component of claim 1, wherein:
the runtime metrics further comprise a measure of overall processor core utilization, and
the instructions further cause the processor circuitry to:
initiate the power optimization action to transition the computing system into the power efficiency mode when the overall processor core utilization is below an overall processor core utilization threshold.

7. The component of claim 6, wherein the instructions further cause the processor circuitry to:
operate the computing system in or transition to a performance mode when the overall processor core utilization is above the overall processor core utilization threshold.

8. The component of claim 1, wherein:
the runtime metrics further comprise a measure of overall processor core concurrency, and
the instructions further cause the processor circuitry to:
initiate the power optimization action to transition the computing system into the power efficiency mode when the overall processor core concurrency is within a predefined overall processor core concurrency range.

9. The component of claim 8, wherein the instructions further cause the processor circuitry to:
operate the computing system in or transition to a performance mode when the overall processor core concurrency is outside of the predefined overall processor core concurrency range.

10. The component of claim 1, wherein the dynamic monitoring of system-critical task residency is performed across central processor unit (CPU) cores, and the dynamic monitoring of user-critical foreground application utilization is performed across heterogeneous processor cores.

11. The component of claim 10, wherein the heterogeneous processor cores comprise a central processor unit (CPU), graphics processor unit (GPU), and/or neural processor unit (NPU) cores.

12. The component of claim 1, wherein the initiation of the power optimization action comprises transmitting a power efficiency signal to a power control unit of the computing system.

13. The component of claim 1, wherein the power optimization action comprises dynamically parking a subset of the processor cores that are performance-oriented processor cores.

14. The component of claim 1, wherein the power optimization action results in a reduction of peripheral component interconnect bandwidth.

15. The component of claim 1, wherein the power optimization action results in a reduction in processor core frequency, memory frequency, or Wi-Fi power.

16. The component of claim 1, wherein the component is comprised within a power control unit of a System-on-Chip (SoC).

17. A computing system, comprising:
a System-on-Chip (SoC) including processor cores and a power control unit;
processor circuitry executing an operating system, which is configured to:
dynamically monitor runtime metrics across the processor cores, wherein the runtime metrics comprise a measure of system-critical task residency and a measure of user-critical foreground application utilization; and
initiate a power optimization action by transmitting a power efficiency signal to the power control unit,
wherein the power control unit is configured to transition the SoC into a power efficiency mode when the system-critical task residency is below a system-critical task residency threshold and the user-critical foreground application utilization is below a user-critical foreground application utilization threshold.

18. The computing system of claim 17, wherein:
the runtime metrics further comprise a measure of overall processor core utilization, and
the processor circuitry executing the operating system is further configured to:
initiate the power optimization action to transition the computing system into the power efficiency mode when the overall processor core utilization is above an overall processor core utilization threshold.

19. The computing system of claim 17, wherein:
the runtime metrics further comprise a measure of overall processor core concurrency, and the processor circuitry executing the operating system is further configured to:
initiate the power optimization action to transition the computing system into the power efficiency mode when the overall processor core concurrency is within a predefined overall processor core concurrency range.
